(19) United States
(12) Patent Application Publication
(10) Pub. No.: US 2003/0122004 A1
(43) Pub. Date: Jul. 3, 2003

(54) Method of and apparatus for juniper harvesting

(76) Inventors: David C. Allen, Redding, CA (US); Timothy R. Thayer, Susanville, CA (US)

Correspondence Address: JENKENS & GILCHRIST, 3200 Fountain Place, 1445 Ross Avenue, Dallas, TX, 75202-2799, US

(21) Appl. No.: 10/305,659

(22) Filed: Nov. 26, 2002

Related U.S. Application Data
(60) Provisional application No. 60/334,975, filed on Nov. 30, 2001.

(51) Int. Cl. B02C 7/00; B02C 17/02

(52) U.S. Cl. 241/24.29

(57) ABSTRACT

A juniper harvesting system and method including an array of select vehicles particularly adapted for the cutting, chipping and collecting of vegetation at a single location and transporting the collected vegetation to another site. The vegetation may be juniper, and its subsequent use being the generation of power. Conventional and customized logging equipment is provided in a system for the aforesaid cutting, chipping, and collecting of large volumes of biomass fuel chips from juniper in an economically viable and environmentally acceptable fashion.

### CROSS REFERENCES TO RELATED APPLICATIONS

This U.S. patent application incorporates herein by reference, and claims priority from U.S. Provisional Application 60/334,975 filed Nov. 30, 2001.

### BACKGROUND

1. Technical Field of the Invention

The present invention relates to the harvesting of vegetation to be used as combustible fuel for energy generation and the like, and more particularly, but not by way of limitation, to the harvesting of juniper in an environmentally acceptable fashion and its conversion to biomass for combustion and the generation of electricity and the method of business associated therewith.

2. History of Related Art

The generation of electricity is an obviously critical component of any industrialized society. Today, electricity is generated worldwide for a variety of commercial and residential purposes and in a variety of ways. The acknowledged methods of electrical power generation include hydroelectric systems, nuclear facilities, solar collector installations, and coal and gas-fired furnaces which power steam turbines. In addition to these conventional techniques, other environmentally sensitive approaches have found acceptance, such as the tapping of the earth's natural, geothermal resources. Although requiring considerably less combustible fuel, both hydroelectric and geothermal energy generation systems are geographically specific and functional only in certain geological locales. Steam turbines powered by the heat of external combustion can be installed in virtually any locale.

In recent years, the utilization of non-fossil fuel for the requisite combustion in conventional energy generation has grown in importance. The flexibility of using non-fossil fuels and the positive environmental considerations therefrom have resulted in an emphasis on alternative energy sources of which vegetation is an option. Non-fossil fuels include wood, grain based fuels, and other organic substances that can be harvested and used for fuel in combustion systems. Such organic matter is often referred to as biomass. Biomass generation systems have a number of advantages over conventional fuels such as fossil, nuclear and even solar generating systems referenced above. Environmental assessments are, however, important considerations in all such systems.

One of the advantages of biomass as an energy generation fuel is its ability to be replenished in an earthen area. This has direct environmental advantages. It is well known that areas can be harvested multiple times for both food and timber. Likewise, vegetation, useful as biomass, can be removed from existing earthen areas, which are then allowed to be used for the growth of other more desirable vegetation. For example, the juniper is prolific and invasive in mountain and desert regions, but, because of its shape and twisted grain, has no commerical value (except in minor quantities as firewood) and therefore is not harvested by the timber or paper industries. In addition, the invasive spread of juniper is steadily reducing habitat of native shrubs, forbs, and grasses, and its voracious consumption of groundwater has reduced water availability significantly within the region. The removal of the juniper is typically not economically viable without some benefit being derived from the juniper harvesting. The cost of cutting, chopping, shipping, handling and storing the juniper is, in and of itself, prohibitive unless a commercial value can be derived from the cut juniper. Environmentally acceptable methods and apparatus must, however, be used which may directly impact the aforesaid economic viability.

By way of example of the above, juniper growth is well-recognized in the California-Oregon High Transition Region. There exists approximately 2.5 million acres of concentrated juniper, virtually all of which is unnatural and unwanted. In the past decade, several attempts at eradication of such juniper have been made, including prescribed fire, commercial firewood enterprises and biomass fuel production using conventional logging equipment and practices. All have failed because of one reason or another. Implications for juniper removal aside from the commercial value of the biomass include reestablishment of native plants in the area in which the juniper has been removed. Additionally, habitat restoration for several bird and mammal species may also be possible in addition to reclaiming grazing land and water supply regions for both public and private land owners.

The present invention provides such a system for and method of achieving a usefulness for the juniper tree. The present invention sets forth a method of and apparatus for converting juniper growth regions into biomass for efficient energy generation.

### SUMMARY OF THE INVENTION

The present invention relates to juniper harvesting systems and methods therefor. More particularly, one aspect of the present invention includes assembling an array of select vehicles particularly adapted for juniper harvesting for the cutting, chipping and specialized transportation thereof in accordance with the specifics thereof set forth herein.

In a further aspect, the present invention includes the utilization of a combination of conventional and customized logging equipment in a unique system of cutting, chipping, and collecting large volumes of biomass fuel chips from juniper at a single location in an environmentally accepted fashion. The methods of and apparatus for juniper harvesting of the present invention will allow operators to produce large volumes of biomass fuel chips in such an environmentally approved fashion much faster than previously possible with fewer personnel and less ground disturbance.

In yet another aspect, the present invention includes a method of harvesting foliage for the creation of biomass in an environmentally acceptable fashion for the generation of electricity, comprising the steps of engaging the foliage, felling the engaged foliage, and chipping the felled foliage into biomass. The chipped foliage is then discharged and received for transporting the chipped foliage to a collection site.

In a further aspect, the invention includes a combination of conventional and customized logging/harvesting equipment which cuts, collects, and chips the foliage which is then transported to be combusted to generate electricity.

Yet a further aspect of the invention includes a foliage harvesting system for the creation of biomass in an environmentally acceptable fashion for the generation of electricity. The system comprises a first vehicle adapted for engaging, cutting and moving foliage, the foliage having differing growth patterns therein. A second vehicle is adapted to be positioned relative to the first vehicle for receiving and handling chip foliage received from the first vehicle. The second vehicle is constructed to pulverize foliage and discharge the pulverized foliage from the second vehicle. A third vehicle is adapted for positioning adjacent the second vehicle for receiving the discharge of pulverized foliage therefrom and hauling the pulverized foliage from the second vehicle to a designated location. In one embodiment, the first vehicle also comprises a mobile body having a hydraulically actuated arm disposed thereon, the hydraulically actuated arm having a distal end, the distal end comprising a clamping unit adapted to clamp and maneuver the foliage and a cutting unit adapted to sever the foliage from the ground therebeneath. In yet another embodiment, the second vehicle comprises a mobile body having a grasping arm disposed at a front, a frontal region adjacent the grasping arm adapted for receipt of foliage therein, a shearing region adjacent the frontal region, the shearing region being adapted for grinding and chipping foliage, and a discharge chute formed at a rear end of the mobile body adapted to discharge foliage from the shearing region.

In another embodiment the invention includes the same described foliage and harvesting system, wherein the third vehicle comprises a wheel base having a plurality of tires mounted thereon, a vehicle chassis coupled to the wheel base, a pulverized foliage collection vessel pivotally mounted on the vehicle chassis, the pulverized foliage collection vessel having hydraulically actuated systems configured therewith to enable the pulverized foliage collection vessel to be angulated relative to a delivery site, a cab mounted on the vehicle chassis to allow a user to situate therein, and a clearing mechanism mounted on a forward side of the cab adapted for manipulating the ground and other objects forward to the cab.

### BRIEF DESCRIPTION OF THE DRAWINGS

A more complete understanding of the method and apparatus of the present system may be obtained by reference to the following Detailed Description taken in conjunction with the accompanying Drawings wherein:

FIG. 1 is a diagrammatic illustration of a juniper harvesting system constructed in accordance with the principles of the present invention for the harvesting of juniper trees to be used as biomass for the generation of electricity;

FIG. 2A is an enlarged view of the juniper cutting vehicle of FIG. 1 illustrating in more detail the operation thereof;

FIG. 2B is an enlarged view of the juniper processing and chipping vehicle of FIG. 1 illustrating the operation thereof in accordance with the principles of the present invention;

FIG. 2C is an enlarged view of the biomass collection and transportation vehicle of FIG. 1 illustrating the operation thereof in association with the other vehicles of the system of the present invention;

FIG. 3 is a side elevational view of the biomass storage and transportation vehicle of FIG. 2C illustrating the dumping of juniper biomass at a given location;

FIG. 4 is an illustration of the transfer of said collected juniper biomass at said designated location to a transportation vehicle for delivery to an energy generation site;

FIG. 5 is a side elevational view of the discharge of collected juniper biomass from said transportation vehicle of FIG. 4 at an energy generation location specifically adapted for the utilization of biomass for the generation of electricity; and

FIG. 6A is a side view of a modified collection and transportation vehicle of FIG. 2C illustrating the modifications thereto for purposes of effecting the system of the present invention;

FIG. 6B is a rear view of the modified collection transportation vehicle of FIG. 6A;

FIG. 6C is an enlarged lower portion of the rear of the modified collection vehicle of FIG. 6B illustrating a door control mechanism;

FIG. 6D is a fragmentary partially perspective view of the modified collection vehicle of FIG. 6A with the rear door in an open configuration;

FIG. 7A is a side view of an alternate embodiment of a modified collection and transportation vehicle of FIG. 2C illustrating the modifications thereto for purposes of effecting the system of the present invention; and

FIG. 7B is a rear plan view of the modified collection and transportation vehicle of FIG. 7A.

### DETAILED DESCRIPTION

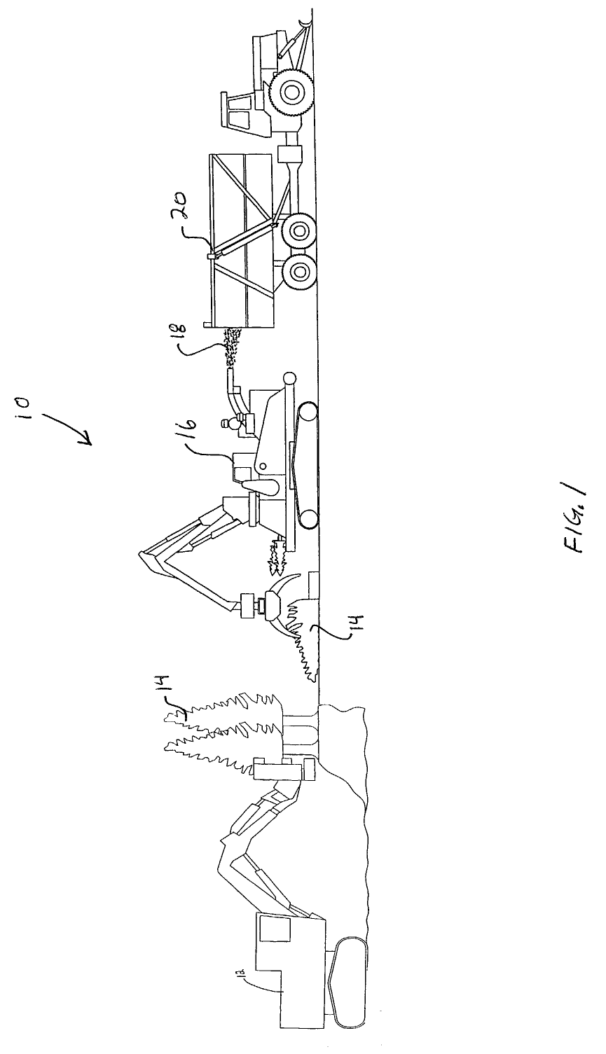

Referring first to FIG. 1, there is shown a juniper harvesting operation set forth in accordance with the principles of the present invention. The juniper harvesting operation as therein set forth utilizes a harvesting system 10 incorporating a first vehicle 12 adapted for engaging, cutting and moving felled juniper trees 14 relative to a juniper chipping vehicle 16 specifically adapted for handling and chipping the felled juniper trees 14. The juniper chipping vehicle 16 discharges the chipped juniper in the form of chipped juniper, or mulch 18, into a modified transport vehicle 20 (also referred to herein as a modified forwarder) adapted for hauling the mulch 18 to a designated location for subsequent handling and the commercial utilization of said mulch. The system 10 of the present invention may also be seen to incorporate, in this particular embodiment, three specially designed vehicles having the specialized applications and/or modifications described below. The type of vehicle for a select operation and the particular modification thereto will be described in more detail below relative to the innovative juniper harvesting system of the present invention.

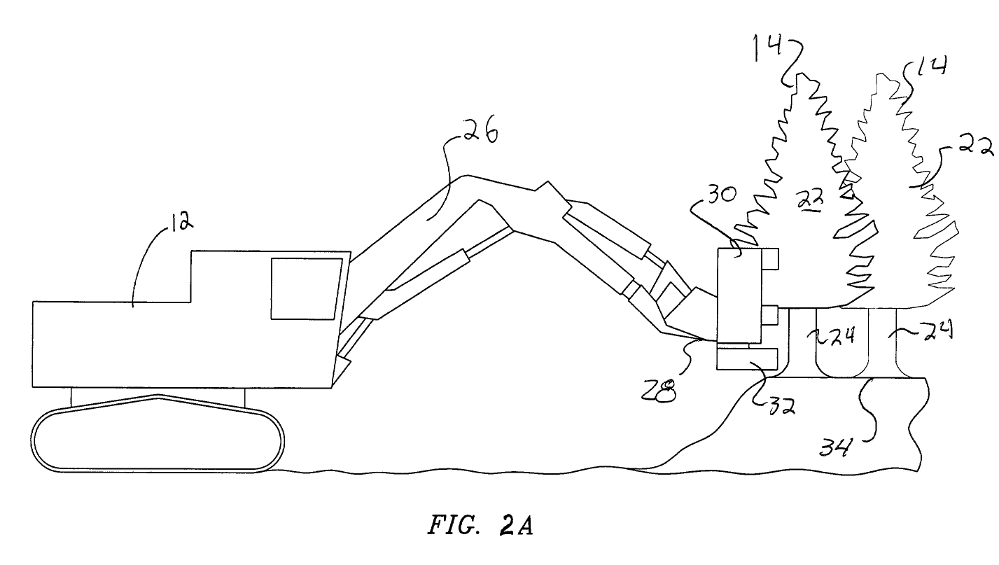

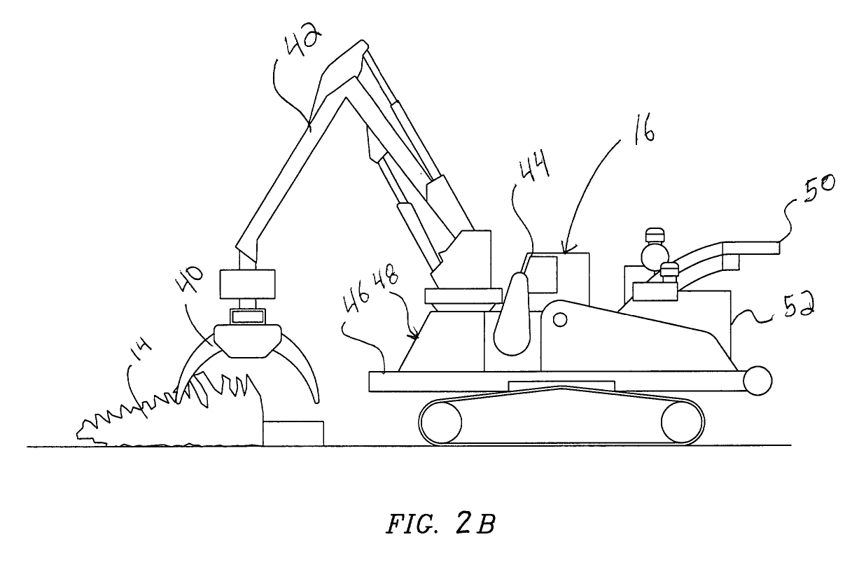

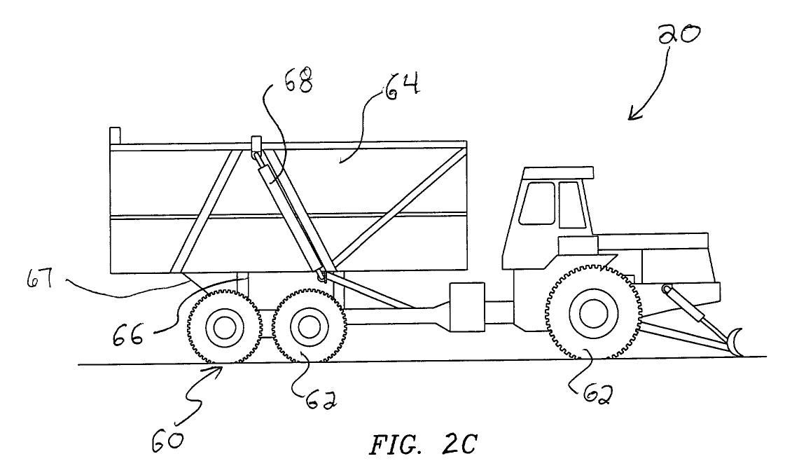

Referring now to FIG. 2A, there is shown a first vehicle 12 adapted for engaging and cutting or shearing juniper trees close to the ground. The juniper trees 14 are shown herein for purposes of reference having green vegetation portions 22 extending outwardly from trunk regions 24. It should be noted that juniper trees grow in a variety of shapes and sizes in which the wooden trunk portions 24 may vary in diameter, shape and complexity relative to the cutting thereof. Likewise, the green foliage section 22 may be formed in a variety of configurations, many of which are not evenly shaped as shown diagrammatically in FIG. 2A.

Still referring to FIG. 2A, the cutting vehicle 12 includes an hydraulically actuated arm 26 having a distal end 28 adapted for clamping and cutting the juniper trees 14. In this regard, distal end 28 includes a clamping unit 30 and a cutting unit 32 adapted to work in cooperation one with the other to sever the juniper 14 from the ground 34 therebeneath. By severing the juniper 14 from the ground 34, said juniper is in a condition to be handled and converted into biomass in accordance with the principles of the present invention.

Referring now to FIG. 2B, there is shown a juniper tree chipping or pulverizing vehicle 16 adapted specifically for picking up the felled juniper trees 14 left by the cutting vehicle 12 and converting said juniper trees 14 to a chipped mass for discharge outwardly into a collection vehicle or vessel. Consistent therewith, the vehicle 16 shown in FIG. 2B includes a grasping claw 40 positioned at the end of a grasping arm 42 which is hydraulically actuated relative to the vehicle body 44 for engaging, securing and manipulating a felled juniper bush or tree 14. The vehicle body 44 includes a frontal region 46 having an area 48 formed therein adapted for receipt of a juniper bush therein for the grinding and chipping thereof Once ground and chipped, the juniper bush 14 is discharged from the discharge chute 50 at a rear end 52 of the vehicle body 44. As will be described in more detail below, the discharged particles of the juniper bush 14 are collected for use as biomass fuel.

Referring now to FIGS. 2A and 2B in combination, it is appropriate to further describe the use by and operation of the mobile vehicles 12 and 16 of the present invention relative to the stationary juniper bushes or trees 14. Each of the vehicles 12 and 16 are shown to be constructed with appropriate tracks to allow for the selective movement, positioning and orientation of the vehicles. Because such track mounted vehicles are effective in rugged terrain and may be positioned in a wide variety of rocky ground conditions, such vehicles must also be transported to the site for which the harvesting of juniper trees 14 is required. The transportation and positioning of such vehicles 12 and 16 is well known in the industry and further description is not provided herein.

Referring now to FIG. 2C, there is shown a forwarder vehicle 20 specifically adapted for receipt and conveyance of the chipped juniper 14 received from the pulverizing vehicle 16. The modifications of the vehicle 20 referred to herein, is designed for improving efficiency of the system 10 of the present invention. In that regard, the vehicle 20 includes a wheel base 60 having a plurality of tires 62 mounted thereon for the passage of the vehicle 20 upon both rough terrain in the vicinity of the junipers 14, as well as on the open road (not shown). Likewise, the vehicle 20 includes a chipped juniper collection vessel 64 that is specifically designed and constructed for the collection, transporting and delivery of the chipped juniper portions therein. In that regard, the collection vessel 64 is pivotally mounted on a chassis 66 of the vehicle 20 with hydraulically actuated systems 68 configured therewith to enable the collection vessel 64 to be angulated relative to a particular delivery site. Details of and aspects for the construction modification and use of the vehicle 20 will be set forth in more detail below.

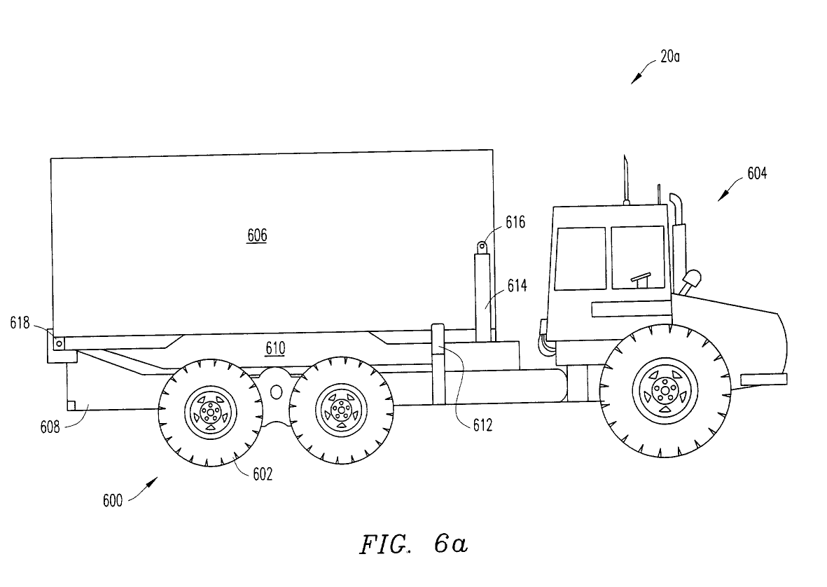

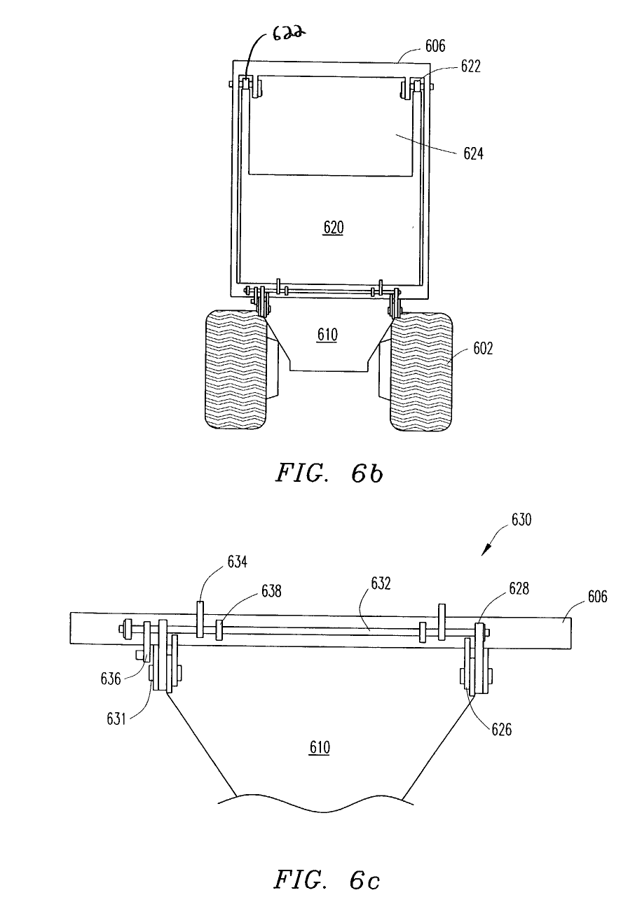

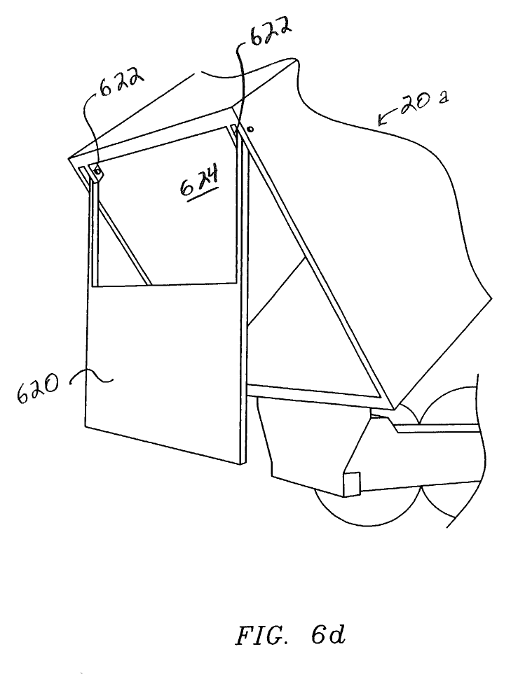

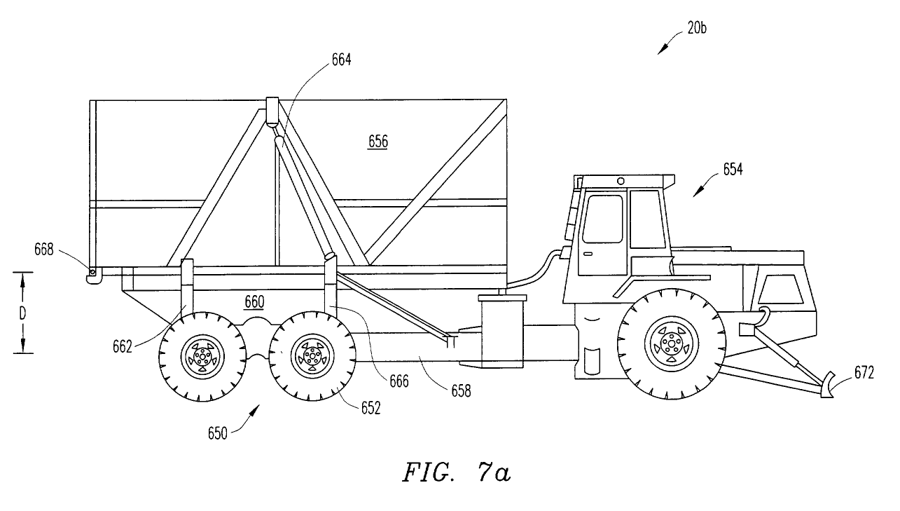

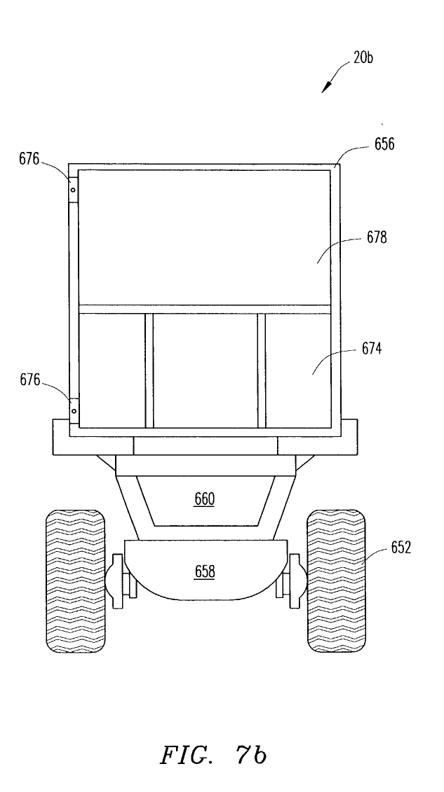

As further referenced below, the vehicle 20 is also referred to as a forwarder. Applicants have found that the conversion of a forwarder used in the logging industry, as further described below, can be modified with the addition of the pivotal collection vessel 64 to be an effective means of collection, receipt, transportation and delivery of chipped juniper in the aforesaid environmentally acceptable fashion. In that regard, additional drawings of the modified forwarder are showed herein in the form of sketches by one of the Applicants hereof. The drawings of FIGS. 6A-6D illustrate the modifications necessary to create the particular operation characteristics of the forwarder vehicle 20 where the aspects thereof include the utilization of a “possum belly” for the accommodation of more chipped juniper as well as lowering the center of gravity with a full load. These aspects are submitted to be shown in the drawings of FIGS. 6A-6D, and in addition in the drawings of an alternate embodiment of FIGS. 7A-7B.

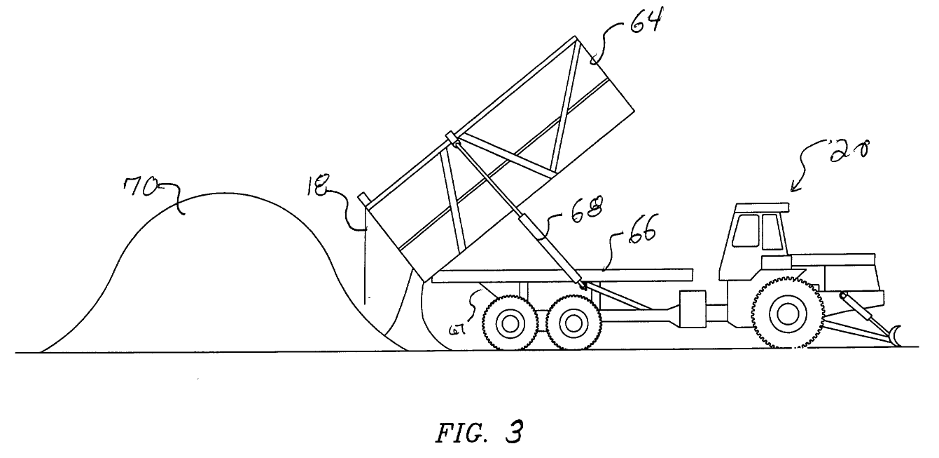

Referring now to FIG. 3, there is shown a vehicle 20 with the collection vessel 64 shown in an angulated position relative to the chassis 66. The hydraulic system 66 has been actuated to create an angulation of the vessel 64 about the chassis 66 to allow the discharge of the chipped juniper 18 into a mound 70 at a site centrally disposed relative to delivery vessels, as described in more detail below for purposes of facilitating the use of biomass of mound 70 for the generation of energy.

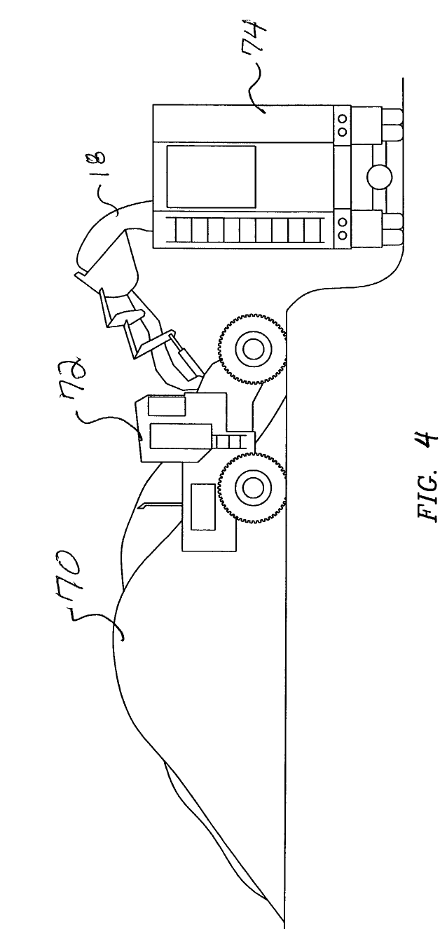

Referring now to FIG. 4, the mound 70 of ground juniper biomass 18 is shown being moved by a conventional earth mover or the like 72 into a conventional dump truck or the like 74 adapted to receive the introduction of the ground biomass 18 through an upper region thereof The dump truck 74 is adapted for movement on open highways to a select delivery site as described below.

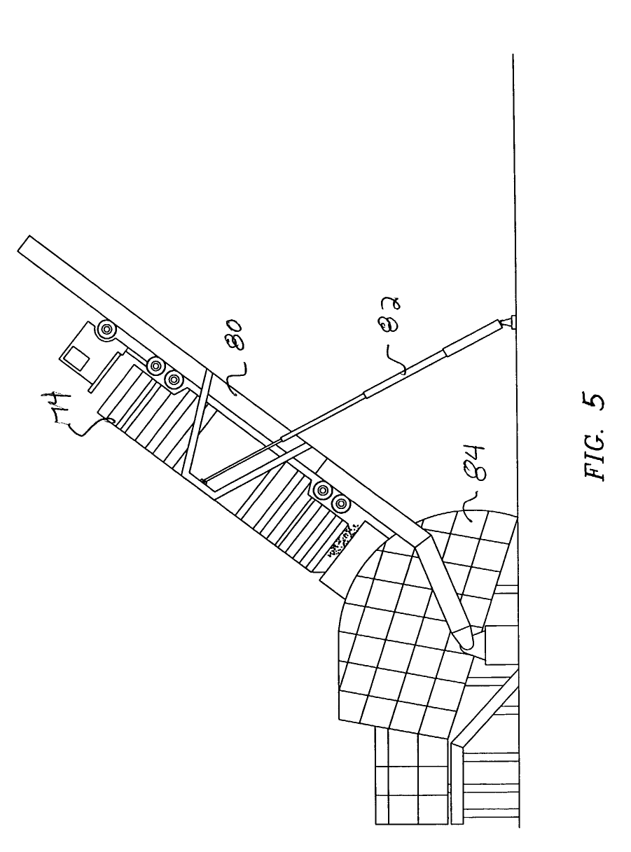

Referring now to FIG. 5, the dump truck 74 is shown positioned upon a ramp 80 that is hydraulically operated with hydraulic system 82 to angulate said dump truck relative to a receiving vessel 84 adapted for receiving the ground biomass 18 therein and the delivery of the ground biomass to the requisite regions of a power generation plant, in accordance with the principles of the present invention. The use of ramp 80 is conventional.

Referring now to FIGS. 6A through 6D, there are shown the drawings of equipment modifications to vehicles incorporated by Applicants for use in accordance with the principles of the present invention. It may be seen that the modifications allow an expansion of the bin, enlarging the bin from the Applicants' prior understanding of 28 cubic yards to a current 45 cubic yard capacity. The modifications also include a positioned hydraulic lifting ram moved from vertical to 45 degrees forward. Also added were support struts extending from the base of the hydraulic rams to the chassis and diagonal braces on the forward side section of the bin. A cross-over brace connected to the top fastens the two hydraulic rams. These and other changes were deemed necessary by one or more of the Applicants herein. Additional changes include a bin door. The door is hinged at the top as opposed to one side for more efficient opening during dumping. The Applicants also added a door latch assembly controlled from the driver's seat similar to that on the valve mate forwarder illustrated herein along the bottom of the door. Ceiling vents were added for pressure release and air exhaust, which may comprise openings or the like formed on the ceiling of the vehicle. Support gussets 67 (FIG. 2C), which may be triangular in shape, were added to connect the bin-frame to the chassis.

Referring to FIGS. 6A-6B, a forwarder vehicle 20a and components thereof are shown. The forwarder vehicle 20a includes a wheel base 600 having a plurality of tires 602 mounted thereon for the passage of the vehicle 20a upon both rough terrain as well as on the open road (not shown). The forwarder vehicle 20a includes a cab section 604 adapted to receive an operator therein, and pulverized foliage collection vessel 606, which has been lifted a predetermined distance D from a chassis 608 of the forwarder vehicle 20a.

A lower section 610 of the pulverized foliage collection vessel 606 protrudes toward the chassis 608, and is adapted to hold additional pulverized foliage therein. Support posts 612 are connected to the chassis 608 and extend on respective side surfaces of the pulverized foliage collection vessel 606 and for orienting the pulverized foliage collection vessel 606 with respect to the forwarder vehicle 20a.

A hydraulic ram 614 is connected to the chassis 608 and the pulverized foliage collection vessel 606. A hinge 616 is provided between the ram 614 and vessel 608, such that the hydraulic ram 614 may be adapted to lift the pulverized foliage collection vessel 606 about a vessel pivot hinge 618 to empty pulverized therefrom.

Referring specifically to FIG. 6B, a rear plan view of the forwarder vehicle 20a is shown. The forwarder vehicle 20a includes a door 620 coupled to the pulverized foliage collection vessel 606 by a plurality of door hinges 622. The door defines an open space 624 at an upper portion thereof to allow pulverized foliage to be deposited within the pulverized foliage collection vessel 606.

Referring now to FIG. 6C, there is shown a top plan view of a door retainer 630 adapted for securing the door 620 to the collection vessel 606. The door retainer 630 includes a rotatable bar 632, at least one door latch 634 connected to the rotatable bar 632 for maintaining the position of the door 620 with respect to the pulverized foliage collection vessel 606, an inner hinge 626 and an outer hinge 628 connected to the rotatable bar 632 at both ends of the rotatable bar 632, and a control hinge 636 connected to the rotatable bar 632 and to a hydraulic cylinder (not shown). Bar retainers 638 further secure the rotatable bar 632 to the pulverized foliage collection vessel 606 while allowing rotation of the rotatable bar 632 therethrough. A series of five detailed drawings of front and side elevations of various parts of the door retainer 630 are shown, the location of which is so indicated relative to the door retainer drawing of 6D.

Still referring to FIG. 6C, the control hinge 636 operates to withdraw the latch 634 from the door 620, such that the door may freely swing about hinges 622 (FIG. 6B) to allow dumping of pulverized foliage from the pulverized foliage collection vessel 606 to a desired location.

Accordingly, when the pulverized foliage collection vessel 606 is raised by the hydraulic ram 614, the control hinge 636 releases the door 620 and allows the door 620 to swing away from the pulverized foliage collection vessel 606, thereby opening the pulverized foliage collection vessel 606. The positioning of the pulverized foliage collection vessel 606 with the open door 620 thereby allows the pulverized foliage stored therein to be released from the pulverized foliage collection vessel 606 onto a desired location.

Still Referring to FIG. 6D, there is shown a partially perspective view of the rear of the forwarder vehicle 20a shown in FIG. 6B. The door 620 of forwarder vehicle 20a is shown pivoting outwardly from the body of the forwarder along the door hinges 622. The outward swinging of the door defines access to the open space 624 within the forwarder and allows pulverized foliage to be discharged therefrom.

Referring now to FIGS. 7A-7B, an alternate embodiment of a forwarder vehicle 20b is shown in side plan and rear plan views, respectively. The forwarder vehicle 20b includes a wheel base 650 having a plurality of tires 652 mounted thereon for the passage of the vehicle 20b upon both rough terrain as well as on the open road (not shown). The forwarder vehicle 20b also includes a cab section 654 adapted to receive an operator therein, and pulverized foliage collection vessel 656, which has been lifted a predetermined distance D from a chassis 658 of the forwarder vehicle 20b.

A lower section 660 of the pulverized foliage collection vessel 656 protrudes toward the chassis 658, and is adapted to hold additional pulverized foliage therein. Support posts 662 are connected to the chassis 658 and extend on respective side surfaces of the pulverized foliage collection vessel 656 and for orienting the pulverized foliage collection vessel 656 with respect to the forwarder vehicle 20b.

A hydraulic lifting ram 664 is connected to a modified support post 666 and the pulverized foliage collection vessel 656, and is adapted to lift the pulverized foliage collection vessel 656 with respect to the chassis 658 about a vessel pivot hinge 668 to empty pulverized foliage therefrom. A support strut 670 is connected to the modified support post 666 and the chassis 658 to provide structural support. As described above, the hydraulic lifting ram 664 is adapted to be actuated by a driver from the cab section 654.

The cab section 654 includes a forward plow 672 connected to the front of the cab section 654. The forward plow 672 is hydraulically adapted to raise and lower during movement of the forwarder vehicle 20b. The forward plow 672 may be used to clear and align brush and other objects in front of the forwarder vehicle 20b.

Referring specifically to FIG. 7B, a rear plan view of the forwarder vehicle 20b is shown. The forwarder vehicle 20b includes a door 674 coupled to the pulverized foliage collection vessel 656 by a plurality of door hinges 676. The door defines an open space 678 at an upper portion thereof to allow pulverized foliage to be deposited within the pulverized foliage collection vessel 656. The door 674 is adapted to secure to the vessel 656 to maintain pulverized foliage therein during loading and movement of the forwarder vehicle 20b. After unlocking the door 674 from the pulverized foliage collection vessel 656, the door 674 is adapted to rotate about the hinges 676.

Accordingly, when unloading the pulverized foliage collection vessel 656, the door 674 is unlocked, and the hydraulic lifting ram 664 (FIG. 7A) is actuated by a driver of the forwarder vehicle 20b from the cab section 654 (FIG. 7A), thereby raising the pulverized foliage collection vessel 656 about the pivot hinge 668. The pulverized foliage or other contents in the pulverized foliage collection vessel 656 is then deposited onto a desired location. The hydraulic lifting ram 664 (FIG. 7A) next lowers the pulverized foliage collection vessel 656 to its original position, and the door 674 is locked to the vessel 656.

The above described system 10 provides an effective means for harvesting and processing juniper at a single location. Juniper is known to be a tough, dense tree characterized by thick heavy limbs from ground level to tree top and harvesting and processing it at a single location, as compared to cutting it and transporting the cut foliage to a second location for processing is a significant advantage. Vehicle 12 is capable of grabbing and sharing a juniper 14 as set forth in FIGS. 1 & 2A. The distill end 28 is adapted for clamping and cutting the juniper trees 14 and is specifically adapted for grabbing the juniper tree from the bottom and effecting the cut prior to laying the tree on the ground. The juniper is a difficult tree to shear and a particular type of cutting head must be used. Such cutting heads are available for cutting difficult trees and are known to the logging industry. As described herein, the mobile chipping vehicle 16 of FIG. 2D is self-propelled and, although an unusual piece of equipment, Applicants understand that it has been used previously to access difficult areas and knock-down trees and brush. Such a vehicle 16 may be used around pipelines and power-line right of ways to chip material just for volume reduction to take foliage down from a standing position where it may get in the way of a power line and/or be fuel for an uncontrolled fire. In this manner, the upstanding foliage is converted to chips and typically blown back on the ground, according to Applicants' current understanding of prior uses of this particular piece of equipment. The collection transportation vehicle 20 of FIG. 2C, also referred to herein also as a “forwarder,” is particularly adapted to the operation set forth and shown within the drawings of the present invention. In order to collect the discharge of pulverized foliage from the chipper vehicle 16, the discharge thereof has been modified, according to Applicants, for discharge into Applicants' collection bin 64 of the forwarder 20.

As referenced above, juniper is a high dessert weed species found abundantly in various regions. Because it has no significant commercial value and is spreading uncontrollably because of past grazing and fire suppression practices, its harvesting for biomass may be of great interest for energy generation, particularly if the process has passed governmental environmental assessments. Positive implications for juniper removal include not only the above, but also the reestablishment of native plants and habitat restoration for several bird and mammal species, as well as reclaiming grazing land and water supply. It is known to Applicant that public and private land owners are very supportive of efforts to remove juniper and replace it with native grasses and shrubs. The advantageous social aspects in conjunction with the advantageous commercial and environmental aspects of harvesting and using juniper biomass as set forth herein for energy generation thus provide a significant advantage for use of the present invention.

### GENERAL ASPECTS

The equipment set forth and described herein has been described by the inventors as equipment which was originally manufactured for logging, construction, or transportation applications. Certain modifications have been made to said equipment for improving the effectiveness in the performance of the vehicle in the operation of the system of the present invention. A principle example is the substitution of a dumping receiver-hopper for log bunks on the forwarder 20 which receives chips blown from the mobile chipper and then transport them to another site. The term “forwarder” refers to the vehicle 20 that is shown in FIG. 3 having a vessel 64 mounted upon a chassis 66 thereof The vessel 64 has been substituted for the conventional elongate bars (log bunks) on the forwarder, as one aspect of the present invention.

Relative to the operation of the equipment as set forth herein, Applicants submit that the most distinguishing characteristic of the juniper operation is the way in which the equipment is used in an environmentally acceptable fashion. While there has been some experimentation with mobile chip collection in Sweden, as known by Applicants, there are no known applications by Applicants in North America more specifically related to this aspect. What is known to Applicants is that mobile chippers appear to Applicants to be used for removal and disposable of thinned trees and power line right-of-way clearing or fire-risk reduction applications where the chips produced are simply blown onto the ground as they are produced and left on the ground. Similarly forwarders, as Applicants currently understand their use, are not used to haul chips.

An experimental test in the form of a demonstration was arranged in October/November of the year 2000 in which Applicants leased some and modified equipment to perform a test of the general inventive concept in accordance with a governmental environmental assessment that was subsequently deemed acceptable. The economic viability of the method of and apparatus for the present invention was also confirmed. The present invention thus provides an environmentally acceptable means for harvesting juniper from remote locations (and/or otherwise conventionally inaccessible locations) for the creation of biomass for the generation of electricity as set forth, shown, described and claimed herein.

### SPECIFIC ASPECTS

The present invention as described above sets forth a method of harvesting foliage at a single location for the creation of biomass in an environmentally acceptable fashion for the generation of electricity. The term single location refers to the advantage of performing the cutting and processing at the same general, field location. The method thereof comprises the steps of engaging the foliage, felling the engaged foliage, chipping/pulverizing the felled foliage into biomass at a single location, and discharging the chipped/pulverized foliage into a vehicle for transporting the chipped foliage to a collection site. The step of engaging and felling foliage is accomplished by a first vehicle described herein. Likewise, the step of pulverizing and the step of discharging is accomplished by a second vehicle. Similarly, the step of receiving and the step of transporting is accomplished by a third vehicle.

As set forth above, the method of the present invention includes disposing the second vehicle in a vicinity of foliage to be converted to biomass. It may be recognized that it is an advantage to align the second and third vehicles for the collection and transportation of the felled foliage. In operation, the step of engaging the foliage comprises gripping the foliage from a bottom portion of the foliage and the step of felling the gripped foliage comprises shearing the foliage at a point above the bottom portion of the foliage. The step of felling the gripped foliage also comprises shearing the foliage at a point below the bottom portion of the foliage, which may comprise junipers.

As described above, the present invention also includes a foliage harvesting system for the creation of biomass in an environmentally acceptable fashion for the generation of electricity. The system includes a first vehicle adapted for engaging, cutting and moving foliage, the foliage having differing growth patterns and a second vehicle adapted to be positioned relative to the first vehicle for receiving and handling chip foliage received from the first vehicle. The second vehicle is constructed to pulverize foliage and directionally discharge the chipped foliage from the second vehicle. A third vehicle is also provided and adapted for positioning adjacent the second vehicle for the discharge of chipped foliage therefrom and hauling the chipped foliage from the second vehicle to a designated location. The first vehicle may include a mobile body having a hydraulically actuated arm disposed thereon, the hydraulically actuated arm having a distal end, the distal end comprising a clamping unit adapted to clamp and maneuver the foliage and a cutting unit adapted to sever the foliage from the ground therebeneath. Likewise, the second vehicle described above includes a mobile body having a grasping arm disposed at a front end of a grasping arm, a frontal region adjacent the grasping arm adapted for receipt of foliage therein, a shearing region adjacent the frontal region, the shearing region being adapted for grinding and chipping foliage, and a discharge chute formed at a rear end of the mobile body adapted to discharge foliage from the shearing region.

Finally, as described above, the third vehicle comprises a wheel base having a plurality of tires mounted thereon, a vehicle chassis coupled to the wheel base, a chipped foliage collection vessel pivotally mounted on the vehicle chassis, the chipped foliage collection vessel having hydraulically actuated systems configured therewith to enable the chipped foliage collection vessel to be angulated relative to a delivery site, a cab mounted on the vehicle chassis to allow a user to situate therein, and a clearing mechanism mounted on a forward side of the cab adapted for manipulating the ground and other objects forward to the cab.

The previous description is of a preferred embodiment for implementing the invention, and the scope of the invention should not necessarily be limited by this description. The scope of the present invention is instead defined by the claims to be submitted in conjunction herewith.

1. A method of harvesting foliage for the creation of biomass in an environmentally acceptable fashion for the generation of electricity, comprising:
engaging the foliage at a location
felling the engaged foliage at said location;
chipping/pulverizing the felled foliage into biomass at said location;
discharging the pulverized foliage;
receiving the discharged pulverized foliage; and
transporting the pulverized foliage to a collection site.

2. The method of claim 1, further comprising:
combusting the transported foliage to generate electricity.

3. The method of claim 1, wherein the step of engaging and felling foliage is accomplished by a first vehicle.

4. The method of claim 3, wherein the step of pulverizing and the step of directionally discharging is accomplished by a second vehicle.

5. The method of claim 4, wherein the step of receiving and the step of transporting is accomplished by a third vehicle.

6. The method of claim 5, further comprising:
disposing the first vehicle in a vicinity of foliage to be converted to biomass.

7. The method of claim 5, further comprising:
disposing the second vehicle in a vicinity of foliage to be converted to biomass.

8. The method of claim 5, further comprising:
disposing the third vehicle in a vicinity of foliage to be converted to biomass.

9. The method of claim 5, further comprising:
aligning the second and third vehicles for the collection and transportation of the felled foliage.

10. The method of claim 1, wherein the step of engaging the foliage comprises:
gripping the foliage from a bottom portion of the foliage.

11. The method of claim 10, wherein the step of felling the gripped foliage comprises:
shearing the, foliage at a point above the bottom portion of the foliage.

12. The method of claim 1, wherein said step of discharging the pulverized foliage includes the step of directionally discharging the pulverized foliage:

13. A foliage harvesting system for the creation of biomass in an environmentally acceptable fashion for the generation of electricity, comprising:
a first vehicle adapted for engaging, cutting and moving foliage at a location, the foliage having differing growth patterns therein;
a second vehicle adapted to be positioned relative to the first vehicle for receiving and handling chip foliage received from the first vehicle at said location,
the second vehicle being constructed to pulverize foliage and discharge the pulverized foliage from the second vehicle at said location; and
a third vehicle adapted for positioning adjacent the second vehicle for receiving the discharge of pulverized foliage therefrom and hauling the pulverized foliage from the second vehicle to a designated location.

14. The foliage harvesting system of claim 13, wherein the first vehicle comprises:
a mobile body having a hydraulically actuated arm disposed thereon, the hydraulically actuated arm having a distal end, the distal end comprising a clamping unit adapted to clamp and maneuver the foliage and a cutting unit adapted to sever the foliage from the ground therebeneath.

15. The foliage harvesting system of claim 13, wherein the second vehicle comprises:
a mobile body having a grasping arm disposed at a front end; a frontal region adjacent the grasping arm adapted for receipt of foliage therein;
a shearing region adjacent the frontal region, the shearing region being adapted for grinding and chipping foliage; and
a discharge chute formed at a rear end of the mobile body adapted to discharge foliage from the shearing region.

16. The foliage harvesting system of claim 13, wherein the third vehicle comprises:
a wheel base having a plurality of tires mounted thereon;
a vehicle chassis coupled to the wheel base;
a pulverized foliage collection vessel pivotally mounted on the vehicle chassis, the pulverized foliage collection vessel having hydraulically actuated systems configured therewith to enable the pulverized foliage collection vessel to be angulated relative to a delivery site;
a cab mounted on the vehicle chassis to allow a user to situate therein; and
a clearing mechanism mounted on a forward side of the cab adapted for manipulating the ground and other objects forward to the cab.

17. A foliage harvesting system, comprising:
a first vehicle comprising:
a mobile body having a hydraulically actuated arm disposed thereon, the
hydraulically actuated arm having a distal end, the distal end comprising a clamping unit adapted to clamp and maneuver the foliage and a cutting unit adapted to sever the foliage from the ground therebeneath at a location;
a second vehicle comprising:
a mobile body having a grasping arm disposed at a front end of a grasping arm;
a frontal region adjacent the grasping arm adapted for receipt of foliage therein;
a shearing region adjacent the frontal region, the shearing region being adapted for grinding and chipping foliage;
a discharge chute formed at a rear end of the mobile body adapted to discharge foliage from the shearing region at said location; and
a third vehicle, comprising:
a wheel base having a plurality of tires mounted thereon;
a vehicle chassis coupled to the wheel base;
a pulverized foliage collection vessel pivotally mounted on the vehicle chassis, the pulverized foliage collection vessel having hydraulically actuated systems configured therewith to enable the pulverized foliage collection vessel to be angulated relative to a delivery site;
a cab mounted on the vehicle chassis to allow a user to situate therein; and
a clearing mechanism mounted on a forward side of the cab adapted for manipulating the ground and other objects forward to the cab.

18. The foliage harvesting system of claim 17, wherein the first, second and third vehicles are posited in a vicinity of foliage to be converted to biomass, and wherein the second and third vehicle are in alignment for transportation of foliage therebetween.

19. The foliage harvesting system of claim 17, wherein the foliage comprises junipers.

20. A method of harvesting foliage for the creation of biomass in an environmentally acceptable fashion for the generation of electricity, including the steps of:
providing a first vehicle adapted for the engagement and felling of foliage at a location for subsequent pulverization into biomass;
providing a second vehicle adapted for the pulverization of said felled foliage at said location and the discharge of said foliage for purposes of biomass collection prior to utilization;
providing a third vehicle adapted for positioning adjacent said second vehicle, and specifically adapted for the receipt of said discharged pulverized foliage at said location;
disposing said first, second and third vehicles in the vicinity of foliage to be converted to biomass;
aligning said second and third vehicles for the collection of said felled foliage;
felling said foliage with said first vehicle; and
transporting said pulverized foliage to a site disposed for the collection thereof and subsequent use for the generation of electricity.

21. The method as set forth in claim 20 wherein said foliage comprises junipers.

22. The method as set forth in claim 20 wherein said third vehicle comprises a motorized unit having a pulverized foliage collection vessel pivotally mounted thereon and adapted for the angulation therewith for the delivery of pulverized foliage therefrom.
